(19) United States
(12) Patent Application Publication
(10) Pub. No.: US 2006/0233265 A1
(43) Pub. Date: Oct. 19, 2006

(54) Joint feed-forward and feedback design for wireless communication systems

(75) Inventors: Dinesh Rajan, Allen, TX (US); Anthony Reid, Plano, TX (US); Giridhar D. Mandyam, San Diego, CA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/107,137

(22) Filed: Apr. 15, 2005

(51) Int. Cl. H04L 27/00

(52) U.S. Cl. 375/259

(57) ABSTRACT

A first method comprises determining a condition of a buffer in a transmitter; using the condition, determining information corresponding to the condition; and communicating the information to a receiver. A second method is disclosed comprising receiving first information corresponding to a condition of a buffer in a transmitter; determining channel state information for a channel from the transmitter to the receiver; using the first information and the determined channel state information, determining second information; and communicating the second information to the transmitter. The second information and the condition of the buffer may be used by the transmitter to determine at least one transmission parameter, e.g., one or both of transmission rate and transmission power for a signal from the transmitter to the receiver. A desired delay constraint for packet traffic over the channel may be achieved.

### TECHNICAL FIELD

This invention relates generally to wireless communication and, more specifically, relates to wireless communication systems that use information to adjust parameter(s) used in communications between transmitters and receivers.

### BACKGROUND OF THE INVENTION

It is well known that intelligent adaptation techniques are required to overcome the multipath fading effects of wireless channels. For example, power and rate adaptation techniques have been considered to improve throughputs or reduce error rates. Capacity and outage performance of fading channels with perfect channel state information (CSI) at the transmitter and receiver has been investigated and it is known that having information about the channel at the transmitter improves the system performance. In many practical wireless systems, feedback of channel information from the receiver to the transmitter has been utilized for transmit power control and, consequently, to reduce error rates. For example IS95, third-generation (3G) code division multiple-access (CDMA) systems for wireless communications typically communicate channel state information from the receiver to the transmitter. This feedback is usually provided using a scalar quantization of the estimated channel state information (e.g., normalized channel gain) at the receiver. Based on the scalar quantization, the transmitter can adapt transmission parameters such as transmit power.

Generally, in practical systems the number of bits of feedback from receiver to the transmitter is limited. The estimate (e.g., measurement) of channel state information is quantized into a number of bits. Current systems utilize the finite (usually between 1-4 bits) amount of feedback information for adaptive transmission at the transmitter. For example, the closed loop power control that exists in cellular systems utilizes such feedback. The quantization of the measured normalized channel gain at the receiver is independent of traffic characteristics and delay requirements and is not adaptive to different scenarios. Thus, designs for typical wireless communication systems are considered to be independent of traffic delay or quality of service (QoS) requirements.

While such feedback information for wireless communication systems is beneficial, additional improvements could be realized.

### BRIEF SUMMARY OF THE INVENTION

The present invention provides techniques that are useful for joint feed-forward and feedback design for wireless communication systems.

In an exemplary aspect of the invention, a method is disclosed that comprises determining a condition of a buffer in the transmitter and, using the condition, determining information corresponding to the condition. The method also comprises communicating the information to a receiver.

In another exemplary embodiment, a transmitter is disclosed comprising a buffer storing packets, a circuit that determines a condition of the buffer, a reception portion that receives information from a receiver, and a circuit using the condition and the information to determine at least one transmission parameter. The determinations of the condition and the at least one transmission parameter are performed so as to achieve a desired delay constraint for packet traffic over a channel from the transmitter to the receiver.

In another exemplary embodiment, a transmitter comprises means for storing packets and means for determining a condition of the means for storing packets. The transmitter also comprises means responsive to the condition for determining information corresponding to the condition and comprises means for communicating the information to a receiver.

In an additional embodiment, a signal bearing medium is disclosed that tangibly embodies a program of machine-readable instructions executable by a processing apparatus to perform operations. The operations comprise determining a condition of a buffer in the transmitter and, using the condition, determining information corresponding to the condition. The operations further comprise communicating the information to a receiver.

In a further embodiment, a method is disclosed that is comprises step for determining a condition of a buffer in the transmitter and, using the condition, step for determining information corresponding to the condition. The method additionally comprises step for communicating the information to a receiver.

In another aspect of the invention, a method comprises receiving first information corresponding to a condition of a buffer in a transmitter and determining channel state information for a channel from the transmitter to the receiver. Using the first information and the determined channel state information, second information is determined. The method further comprises communicating the second information to the transmitter.

In another embodiment, a receiver is disclosed comprising a reception portion, a channel estimator, and a circuit. The reception portion receives first information from a transmitter, the first information corresponding to a condition of a buffer of the transmitter. The channel estimator determines channel state information for a channel from the transmitter to the receiver. The circuit determines second information using the first information and channel state information. The determination of the second information is performed so that a desired delay constraint for packet traffic over the channel is achieved.

In another exemplary embodiment, a receiver comprises means for receiving first information corresponding to a condition of a buffer in a transmitter. The receiver also comprises means for determining channel state information for a channel from the transmitter to the receiver. The receiver additionally comprises means responsive to the first information and the determined channel state information for determining second information. The receiver further comprises means for communicating the second information to the transmitter.

In an exemplary embodiment, another method is disclosed that comprises step for receiving first information corresponding to a condition of a buffer in a transmitter, and step for determining channel state information for a channel from the transmitter to the receiver. The method additionally comprises step for determining, by using the first information and the determined channel state information, second information. The method also comprises step for communicating the second information to the transmitter.

In yet another exemplary embodiment, another signal bearing medium is disclosed that tangibly embodies a program of machine-readable instructions executable by a processing apparatus to perform operations. The operations comprise receiving first information corresponding to a condition of a buffer in a transmitter and determining channel state information for a channel from the transmitter to the receiver. The operations additionally comprise determining, by using the first information and the determined channel state information, second information. The operations also comprise communicating the second information to the transmitter.

In another aspect of the invention, a method is disclosed that comprises gathering channel state information statistics and transmission rate statistics for a channel between a transmitter and a receiver. The following are performed using the channel state information statistics and transmission rate statistics: determining a first function used to calculate first information based on a condition of a buffer of the transmitter; determining a second function used to calculate second information based on channel state information and the first information; and determining a third function used to calculate transmission power and transmission rate based on the second information and the condition of the buffer.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a block diagram of an exemplary wireless communication system in accordance with an exemplary embodiment of the present invention;

FIGS. 2A, 2B, 2C, 2D, 2E, and 2F are graphs representing specific forms of thresholding functions considered;

FIG. 3 is a graph of total loss probability for a buffer size of two packets and various amount of feedback (FB) and feed-forward (FF) information;

FIG. 4 is a graph of total loss probability for a buffer size of three packets and FB information of two bits;

FIG. 5 is a graph of total loss probability for a buffer size of three packets and FB information of three bits;

FIG. 6A is a block diagram of part of a transmission portion of a transmitter allowing multirate transmissions in accordance with an exemplary embodiment of the present invention;

FIGS. 6B, 6C, and 6D are examples of different rates used in the transmission portion shown in FIG. 6A;

FIG. 7A is a graph of packet error rate for the multirate scheme shown in FIG. 6A, for a number of packets per time-slot;

FIG. 7B is a graph, determined using FIG. 7A, of transmission power for number of packets per time-slot (u);

FIG. 8 is a graph of packet error rate versus delay for the multirate scheme shown in FIG. 6A;

FIG. 9 is a graph of packet error rate versus signal to noise ratio (SNR) for the multirate scheme shown in FIG. 6A, for a delay of three packets;

FIG. 10 is a graph of packet error rate versus signal to noise ratio (SNR) for the multirate scheme shown in FIG. 6A, for a delay of two packets; and

FIG. 11 is a flowchart of a method for joint feed-forward and feedback for wireless communication systems.

### DETAILED DESCRIPTION OF EXEMPLARY EMBODIMENTS

As previously described, feedback information about channel state information (e.g., normalized channel gain) is sent from the receiver to the transmitter in certain wireless communication systems. The receiver, through the use of a quantizer, typically quantizes the channel state information into 1-4 bits and sends the bits as feedback information to the transmitter. The transmitter then uses the feedback information to adjust transmission parameters, such as transmission power.

There are two main drawbacks of these schemes. Firstly, there is no optimization of the quantizer coefficients based on delay requirements of the traffic. The quantizer coefficients are used to determine how many bits to be used for feedback information. Secondly, there is no adaptation of the quantizer coefficients based on knowledge of the transmit buffer condition at the receiver.

By contrast, certain exemplary embodiments of the present invention can correct these problems. An exemplary embodiment of the present invention adds a new logical feed-forward channel from the transmitter to the receiver that transports information regarding buffer condition. Another exemplary embodiment of the present invention presents a unified approach to the design of feedback (FB) and feed-forward (FF) communication systems. In this exemplary embodiment, the present invention integrates quality of service (QoS) provisioning (e.g., in the form of meeting delay guarantees) into the design of transmission rate and transmission power adaptation.

Exemplary proposed adaptation techniques are applicable in many different wireless applications including cellular, mesh networks and wide local area networks (WLANs). However, the proposed adaptation techniques are primarily useful in systems that have the possibility of sending finite-rate channel feedback information from receiver to transmitter. Also, if there exists no possibility for feedback from receiver to transmitter due to the fast fading nature of the channel, then the techniques of the present invention might not be useful. Exemplary proposed adaptation techniques are applicable for many different types of traffic including constant bit rate traffic and variable bit rate (VBR) traffic. The latter type of traffic includes, for instance, video traffic like Motion Picture Experts Group (MPEG), and Internet traffic traces.

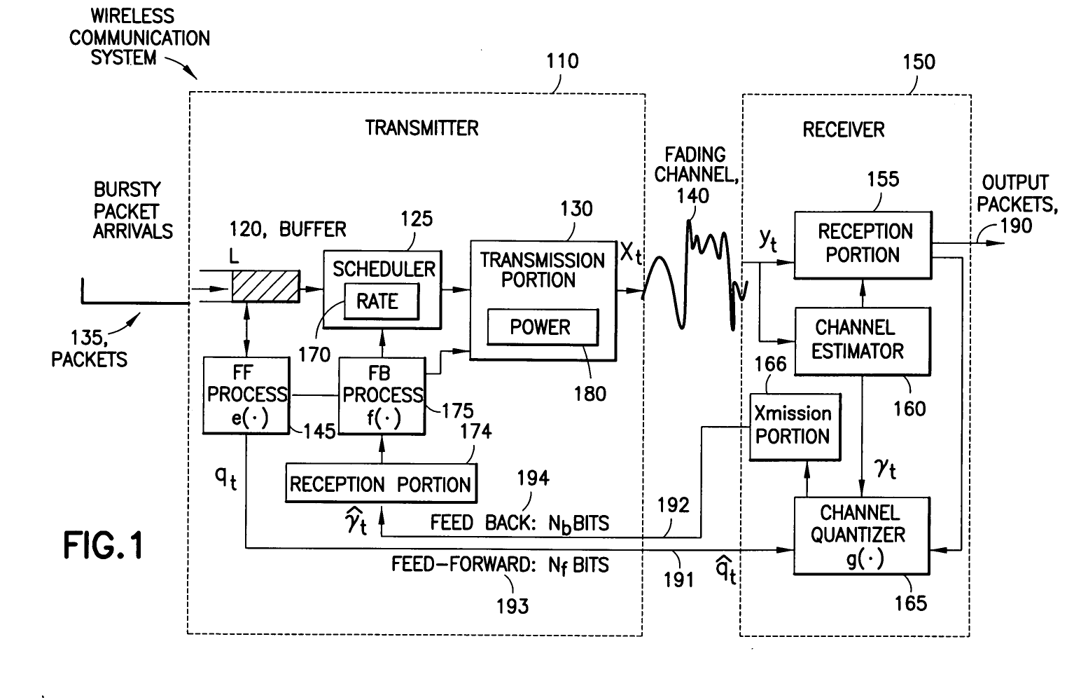

Certain of the proposed techniques can be used to improve both uplink and downlink performance. An exemplary embodiment of the present invention is described for a simple point-to-point wireless communication system, although the techniques presented herein may be used for other systems such as Multiple-Input, Multiple-Output (MIMO) systems. A schematic of an exemplary proposed wireless communication system 100 is shown in FIG. 1. The wireless communication system 100 comprises a transmitter 110 and a receiver 150 that communicate through a channel 140. The channel 140 will be considered to be a fading channel herein. It should be noted that the transmitter 110 and receiver 150 can be combined into a transceiver, if desired.

The transmitter 110 comprises a buffer 120 that is used to hold packets 135, which typically arrive in a bursty fashion. The buffer 120 has, as described in more detail below, a chosen size of L packets 135. For sake of simplicity, it will be assumed that the maximum desired delay of the packets 135 will be the size, L, of the buffer 120. The size, L, of the buffer 120 is a desired delay constraint that is to be achieved. It should be noted that the actual buffer size may differ from the desired delay constraint. However, it is assumed herein that if the buffer 120 already has L packets 135, the L+1 packet 135 will be dropped. When a packet 135 is dropped, one of two things is assumed in an exemplary embodiment: either the dropped packet 135 is retransmitted by a higher layer protocol (e.g., Transmission Control Protocol or TCP, Real Time Transport Control Protocol) or if the data is real-time video/audio, the lost packets do not matter. The total lost packets is determined by the outage rates, as described below. It is assumed that the desired delay constraint is satisfied up to certain losses. The desired delay constraint is sometimes referred to as a statistical Quality of Service (QoS) constraint, e.g, design a scheme so that at most five percent of packets violate a delay bound (e.g., L) of three.

The buffer 120 is coupled to a feed-forward (FF) process 145, which as described in more detail below uses a function shown as e(·). Briefly, the FF process 145 determines a condition (e.g., qₜ) of the buffer 120 and communicates information corresponding to the condition (e.g., \hat{q}ₜ) to the receiver 150, as FF information 193.

The transmitter 110 further comprises a scheduler 125 and a transmission portion 130. In an exemplary embodiment, the scheduler 125 uses a transmission rate 170 that determines how many packets 135 are transmitted during a time-slot. The transmission portion 130 comprises a transmission power 180 that is used during transmission of information on the channel 140 and during a time-slot. Each of the scheduler 125 and the transmission portion 130 is coupled to a feedback (FB) process 175. The FB process 175 receives feedback information 194 from a reception portion 174 of the transmitter 110. Typically, as described in more detail below, both the transmission rate 170 and the power 180 would be determined using one function, although it is possible that multiple functions could be used. In the example of FIG. 1, the function is f(·) and the transmission rate 170 and transmission power 180 are determined by the feedback (FB) process 175. Although not shown, the transmission portion 130 would also contain additional items known to those skilled in the art, such as modulators, channel coders, error correction devices, and the like.

The receiver 150 comprises a reception portion 155, a channel estimator 160, a channel quantizer 165, and a transmission portion 166. The channel quantizer 165 uses a function, g(·), to determine FB information 192. This is described in more detail below. As additionally discussed below, the functions e(·), f(·), and g(·) are defined in order to achieve a desired delay constraint (e.g., the size, L, of the buffer 120) for packet traffic between the transmitter 110 and the receiver 150. Portions or all of the transmitter 110 and receiver 150 may be implemented as circuitry comprising hardware (such as an integrated circuit and/or a programmable gate array), software (such as a process that is loaded into a digital signal processor or other processor), or some combination thereof.

In an exemplary embodiment, the transmitter 110 is adapted to determine (e.g., using FF process 145) an amount, qₜ, of packets 135 in the buffer 120, to quantize (e.g., using FF process 145) this amount using a number, N_{f}, of feed-forward bits, and to communicate this quantized amount, \hat{q}₁, of packets 135 in the buffer 120 to the receiver 150.

The amount, q₁, of packets 135 in the buffer 120 is one example of a condition of a buffer that is used to determine feed-forward (FF) information 193, which is communicated by the transmitter 110 to the receiver 150. Another example of a condition of a buffer is the amount of space remaining in the buffer 120. For instance, assume there is one packet in a buffer of size L. Then, (L−1) or one could be the condition of the buffer. As another example, the condition could be a state of the buffer 120, such as “normal” if the buffer 120 typically has one packet 135 in the buffer 120, “not normal” if greater than one packet 135 is in the buffer 120, or “full” if the buffer 120 is full (e.g., there are L packets in the buffer 120). For the latter, it could be that no FF information 193 is used for a “normal” buffer state but is used for “not normal” and “full” buffer states. As additional examples, the condition could indicate the number of packets 135 arrived in a time window, indicate the maximum waiting time of the packets in the buffer, or indicate the earliest delay expiration timer for the packets 135 in the buffer. For simplicity, the amount, qₜ, of packets 135 in the buffer 120 will be used in the examples given below. The quantized amount, \hat{q}ₜ, is an example of information that corresponds to the condition of the buffer 120.

The determination of the condition of the buffer 120, of qₜ and of information corresponding to the condition (e.g., quantization of qₜ) is shown in FIG. 1 as being performed by a FF process 145. The FF process 145 may be implemented in circuitry comprising hardware, software, or a combination thereof. The FF process 145 may be performed by the buffer 120 (e.g., a process that is implemented by the buffer 120), the scheduler 125, the transmission portion 130, or through any other technique/device suitable for these operations. For instance, the transmitter 110 could be at least partially implemented by a digital signal processor (DSP), and the buffer 120 could be implemented as a first-in, first-out device (FIFO). The FIFO could cause an interrupt for the DSP to be enabled when a packet 135 is received by the FIFO. The DSP could then execute an interrupt process (e.g., FF process 145) that corresponds to the interrupt, and the interrupt process could determine the current number of packets 135 in the buffer 120 and quantize this number.

In the example of FIG. 1, the FB process 175 could be, e.g., another process in the DSP that determines a transmission rate 170 as described in more detail below. The FB process 175 can be implemented as circuitry comprising hardware, software, or a combination thereof and may be implemented as a standalone process or have portions or all of the FB process 175 in the scheduler 125, transmission portion 130 or any other portion of the transmitter 110. The FB process 175 uses the transmission rate 170 and a quantized value (e.g., \hat{γ}ₜ) of an estimate of the channel state information (e.g., γₜ) to determine transmission power 180, as described in more detail below. During a time-slot, the transmission portion 130 transmits the number of packets 135 as determined by the transmission rate 170, and at the transmission power 180. The signal xₜ is produced, and travels through channel 140.

The receiver 150 receives the signal yₜ through the channel 140. The reception portion 155 produces output packets 190 using the received signal yₜ and other techniques, such as demodulation and error correction, as known in the art. The channel estimator 160 produces an estimate of the normalized channel gain, γₜ, which is determined from

$${γ}_{t} = \frac{{\vert {h}_{t} \vert}^{2}}{{σ}^{2}} ,$$

where h, is the complex channel gain and σ is a standard deviation. The estimate of the normalized channel gain is an example of channel state information, and will be also used as the channel state information herein. It is, nonetheless, possible for other channel state information to be used, such as for the case where a constant amplitude constellation is implemented, then, one might want to feedback the phase of γₜ or a phase difference. Additionally, normalized channel gain may also be called channel attenuation and techniques for determining channel attenuation could also be used herein. The channel quantizer 165 determines, using the function g(·), a quantized value, \hat{γ}ₜ, of the channel state information having a number of bits, N_{b}, and based on the quantized amount, \hat{q}ₜ, of packets 135 in the buffer 120 and the estimate of the normalized channel gain, γₜ.

It should be noted that the quantized value, \hat{γ}ₜ, of the estimate of the normalized channel gain is typically communicated through a feedback channel 192 from the transmission portion 166 to the reception portion 174 and may be communicated though any mechanism allowing communication between a receiver 150 and a transmitter. The reception portion 174 then communicates the quantized value, \hat{γ}ₜ, to the FB process 175.

The quantized amount, \hat{q}ₜ, of packets 135 in the buffer 120 is typically communicated through a feed-forward channel 191 and may be communicated though any mechanism allowing communication between a transmitter 110 and a receiver 150. Typically, the quantized amount, \hat{q}ₜ, of packets 135 is communicated to the transmission portion 130 (e.g., through a process associated with the buffer 120), and the transmission portion 130 uses the feed-forward channel 191 to communicate the quantized amount, \hat{q}ₜ, of packets 135 to the reception portion 155 of the receiver 150. The reception portion 155 then forwards the quantized amount, \hat{q}ₜ, of packets 135 to the channel quantizer 165. FIG. 1 shows the feed-forward channel 191 occurring between the FF process 145 and the channel quantizer 165 as an aid in describing and understanding embodiments of the present invention.

It should be noted that the channel 140 is typically a slow fading channel used for the “actual” data transfer (e.g., packet traffic) from the transmitter 110 to the receiver 150. The feedback (FB) information 194 (e.g., \hat{γ}ₜ) and feed-forward (FF) information 193 (e.g., \hat{q}ₜ) are assumed to be sent on “side” channels in an error free manner. The effect of small errors in the “side” channel will not affect the performance of proposed system drastically. The FB information 194 and FF information 193 is only a few bits typically, whereas actual data rates over the channel 140 could be in kilobits (Kb) or megabits (Mb) or even higher.

Most systems have the ability to send a few bits of FB information 194 from the receiver to the transmitter in each frame of data, where each frame is communicated during a single time-slot. It should be noted that each “frame” would contain multiple packets depending on the scheduler 125. In FIG. 1, the wireless communication system 100 transmits FF information 193 from the transmitter 110 to the receiver 150, generally in each frame. Consider a simple single path Rayleigh fading channel 140. At the receiver 150, the channel gain is measured and processed (e.g., as the estimate of the normalized channel gain, γₜ) along with the received FF information 193 and the FB information 194 is generated. For simplicity, the FB information 194 is assumed to be a scalar quantized version of the estimated normalized channel gain. As described in more detail below, the thresholds used by the channel quantizer 165 are determined based on the FF information 193, the estimated channel state, γₜ, and optimization framework used. At the transmitter 110, the FB information 194 is used in conjunction with buffer condition (e.g., qₜ) to optimize the transmission rate 170 and transmission power 180. The optimization framework used to determine the FF information 193 and FB information 194 and the related power and rate control mechanism is described next.

Consider a single user time-slotted system (e.g., wireless communication system 100) in which exactly one packet of fixed size R arrives into a buffer of size L packets 135, at the beginning of every time-slot. This proposed scheme is applicable to variable rate traffic arrivals in a direct manner. The main difference required for VBR traffic would be in the calculation of pᵢⱼ and Π. The number of packets 135 in the buffer 120 at time t is denoted, as stated above, by qₜ. The convention is used that if a packet 135 is transmitted in the same time-slot in which the packet 135 arrived, then the delay equals one. A first-come first-served policy is assumed and thus buffer size L is assumed to be equal to the absolute delay bound, D.

Assume a block fading channel model in which the complex channel gain hₜ is constant over T_{c} consecutive symbols, which is also the length of one time-slot. The complex channel gain hₜ is assumed to vary independently from one time-slot to another. The transmitted signal xₜ depends on the number of packets transmitted at time t and on the coding and modulation scheme used. The complex received signal yₜ is given by, yₜ=hₜxₜ+zₜ, where zₜ is the additive noise. The transmitted signal xₜ, the received signal yₜ and the additive noise zₜ are T_{c} dimensional complex vectors. The real and imaginary parts of hₜ are assumed to be independent zero mean Gaussian, each with variance ½. Also, the additive noise zₜ is assumed to be circularly symmetric Gaussian with zero mean and covariance σ²I_{Tc} where I_{Tc} is the identity matrix of size T_{c}.

It has been shown that the conditional mutual information between xₜ and yₜ is a good indicator of the performance of practical codes; this mutual information is given by

$$I ( {x}_{t} , {y}_{t} / {h}_{t} ) = {T}_{c} log ( 1 + \frac{{P}_{t} {\vert {h}_{t} \vert}^{2}}{{σ}^{2}} ) = {T}_{c} log ( 1 + {P}_{t} {γ}_{t} ) ,$$

where γₜ is an estimate at the receiver of the channel state (as described above) and Pₜ is the transmission power 180. In the examples that follow the estimate of the channel state, γₜ, will be considered to be the normalized channel gain, although other estimates of the channel state may be used.

The total probability Π that a packet 135 arriving at the transmitter 110 is not successfully decoded at the receiver 150 depends on the probability of packet loss due to buffer 120 overflows and the frame error rate of the actual coding scheme. The probability of outage, as an indicator of the frame error rate, may be considered as follows. The outage probability is defined as the following: Π₀=Pr{I(xₜ, yₜ/hₜ)<R}. By using this theoretically defined outage probability, the actual coding scheme used is abstracted away. The total loss probability is given by the following: Π=Prob of buffer overflows+Prob of outage in the channel. For constant arrival of one packet per time-slot, the buffer overflow probability is given by s_{L}(1−e^{-γ}^{_{L,1}}). For the theoretical calculations shown, probability of outage in the channel 140 equals zero. In a practical scheme, probability of outage will depend on the chosen frame error rate.

A class of transmission schemes is now considered in which both transmission parameters such as transmission rate 170 and transmission power 180 are adapted based on channel knowledge at the transmitter and the buffer state. For buffer size L, the various possible transmission rates are 0, 1, . . . , L packets/time-slot. The number of FB and FF bits are chosen to satisfy

$$( 1 + \frac{L ( L + 1 )}{2} ) \leq {2}^{{N}_{f} + {N}_{b}} .$$

As described in more detail below, once the transmission rate 170 is determined, the transmission power 180 is chosen to avoid outages in the channel 140. At the receiver 150, an estimate of the channel state, γₜ, is quantized, using the estimate of the channel state, γₜ and FF information 193, to a finite number of bits as the quantized value, \hat{γ}ₜ. For instance, the estimate of the channel state could be the normalized channel gain. The quantization thresholds used by the channel quantizer 165 are chosen based on the buffer information, \hat{q}ₜ available at the receiver. The actions at the transmitter 110 and receiver 150 can be represented as the following:
Pₜ=f(qₜ, \hat{γ}ₜ),
\hat{γ}ₜ=g(γₜ, \hat{q}ₜ), and
\hat{q}ₜ=e(qₜ).

The design of functions f(·), g(·), and e(·) are important factors that determine system performance and one exemplary case is illustrated herein in which these functions are chosen to minimize packet loss probabilities and to achieve a desired delay constraint (e.g., the size, L, of the buffer 120) for packet 135 traffic between the transmitter 110 and the receiver 150. It should be noted that the transmission rate 170 is a function of (qₜ, \hat{γ}ₜ), and the transmission power 180, Pₜ, is a function of the chosen transmission rate 170 and (qₜ, \hat{γ}ₜ). The function f(qₜ, \hat{γ}ₜ) is used to select both transmission rate 170 and transmission power 180, and as such could be separated into multiple sub-functions, e.g., Pₜ=f₁(qₜ, \hat{γ}ₜ, rate) and rate=f₂(qₜ, \hat{γ}ₜ).

The optimization problem of interest can then be stated as follows:

$${min}_{\{ f , g , e \}} Π given E [ {P}_{t} ] \leq {P}_{0} ,$$

where E[Pₜ] is the expected value of Pₜ and P₀ is the maximum power of the transmitter. Initially, a wireless communication system 100 is focused on having a small number of bits of FF information 193 (e.g., N_{f}=1 or 2 bits). Thus the function e(·) is just assumed in an exemplary embodiment to be a simple thresholding function. The class of functions f, g considered involve the selection of thresholds γ_{k,l}, 1≦l≦k≦L such that during time-slot t, l packets are transmitted if qₜ=k and γ_{k,l}≦γₜ<γ_{k,l+1}, i.e., if buffer 120 has k packets 135 and normalized channel gain lies between certain thresholds. No packets are transmitted in buffer state k if normalized channel gain γₜ<γ_{k,1}. For notational simplicity, let γ_{k,0}=0, γ_{k,k+1}=∝∀k. There is also a natural constraint imposed on the thresholds, namely γ_{k,l}<γ_{k,m} for l≦m, i.e., more packets 135 are transmitted when the normalized channel gain γₜ is higher.

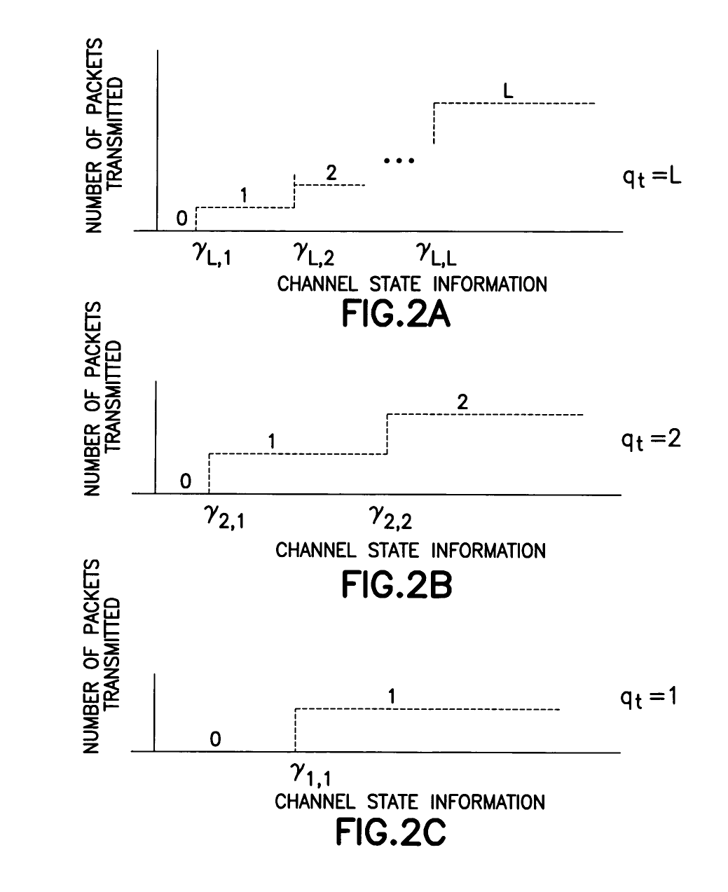

Exemplary thresholding schemes useful for f(·), g(·), and e(·) are illustrated in FIGS. 2A-2F. The thresholding schemes quantize one or more inputs into one of a predetermined number of bit combinations. The thresholds are also the boundary regions of a scalar quantizer of γₜ at the receiver (e.g., the channel quantizer 165). Depending on the value of N_{b} and N_{f}, other thresholds, β₁, β₂, . . . , β_{K} are chosen, where

$$K = {2}^{{N}_{f} + {N}_{b}} - ( 1 + \frac{L ( L + 1 )}{2} ) .$$

These thresholds assist in power control as mentioned below. FIG. 2D illustrates a thresholding scheme useful, e.g., for determining transmission power 180.

FIG. 2E shows an example of thresholding useful for g(·). In the example of FIG. 2E, if the normalized channel gain γ is less than γ_{L,1} and \hat{q}ₜ is 2, then \hat{γ}=000. FIG. 2F shows an example of thresholding suitable for e(·).

Transmission schemes (e.g., determined by f) are considered in which outage does not occur in the channel 140, but only due to packet dropping arising from buffer overflows. Hence, Πₒ=0 and Π=Π_{b}. Zero outage in the channel 140 can be ensured by choosing enough transmission power 180 to ensure that the instantaneous mutual information is greater than R. Formally,

$${P}_{t} = \frac{( {ⅇ}^{tR} - 1 )}{β} ,$$

where γ_{k,l}≦γₜ<γ_{k,l+1}, and β is the largest threshold that lies between γ_{k,l} and γₜ and is given by

$$β = {arg max}_{{\{ {β}_{1} , {β}_{2} , … {β}_{K} , {γ}_{k , t} \}}_{x < {\hat{γ}}_{t}}} x .$$

Since it is assumed that exactly one packet 135 arrives during every time-slot, buffer overflows only occurs in the qₜ=L buffer state. The queue state qₜ forms a stationary Markov chain with L+1 states. The transition probabilities pᵢⱼ between the different queue states, defined as pⱼᵢ=Pr{qₜ₊₁=j=j|qₜ=i}, can be computed through the following:

$${p}_{ji} = \{ \begin{matrix} {ⅇ}^{- {γ}_{i , 1}} - {ⅇ}^{- {γ}_{i , 2}} & i = j \neq L \\ 1 - {ⅇ}^{- {γ}_{i , 1}} & j = i + 1 \\ 1 - {ⅇ}^{- {γ}_{1 , 2}} & i = j = L \\ {ⅇ}^{- {γ}_{i , i - j + 1}} - {ⅇ}^{- {γ}_{i , i - j + 2}} & j < i \\ 0 & else\end{matrix}$$

The stationary probability of being in buffer state qₜ=i, denoted by sᵢ (which is also the invariant distribution of the Markov chain) is then computed from the following:
Cs=s.

where s=[s₀ s₁ s₂ . . . s_{L}], and C is an (L+1)×(L+1) matrix whose i^{th} row and j^{th} column is pᵢⱼ. Thus, the packet loss probability, which depends on the thresholds γᵢⱼ, is given by the following:

$$Π = {Π}_{b} = {s}_{L} {\int }_{0}^{{γ}_{L , 1}} {ⅇ}^{- γ} ⅆ γ = {s}_{L} ( 1 - {ⅇ}^{- {γ}_{L , 1}} ) .$$

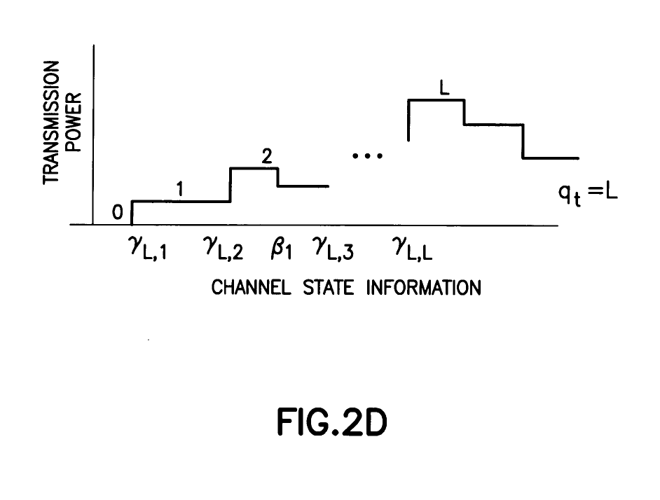

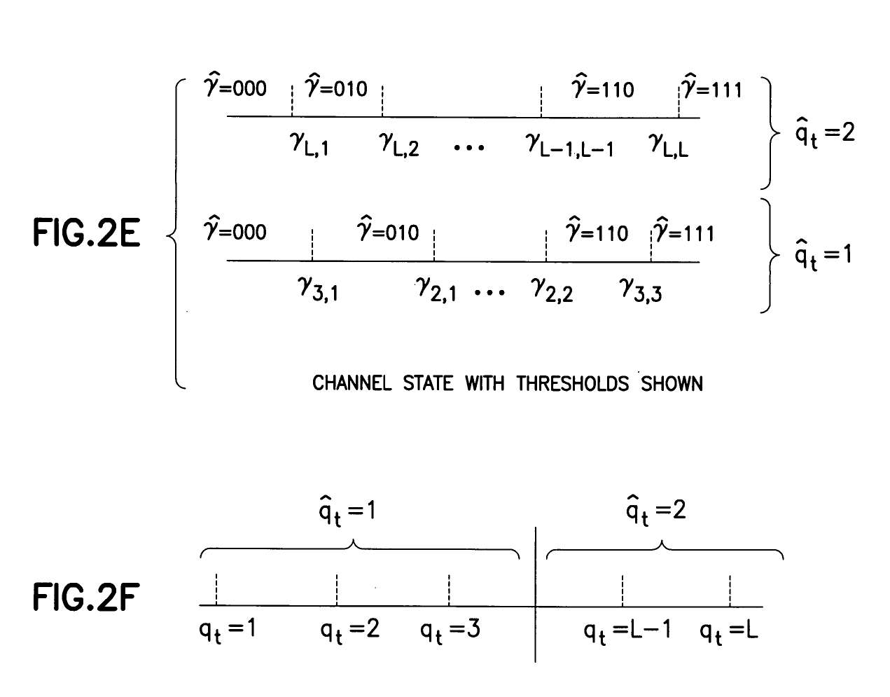

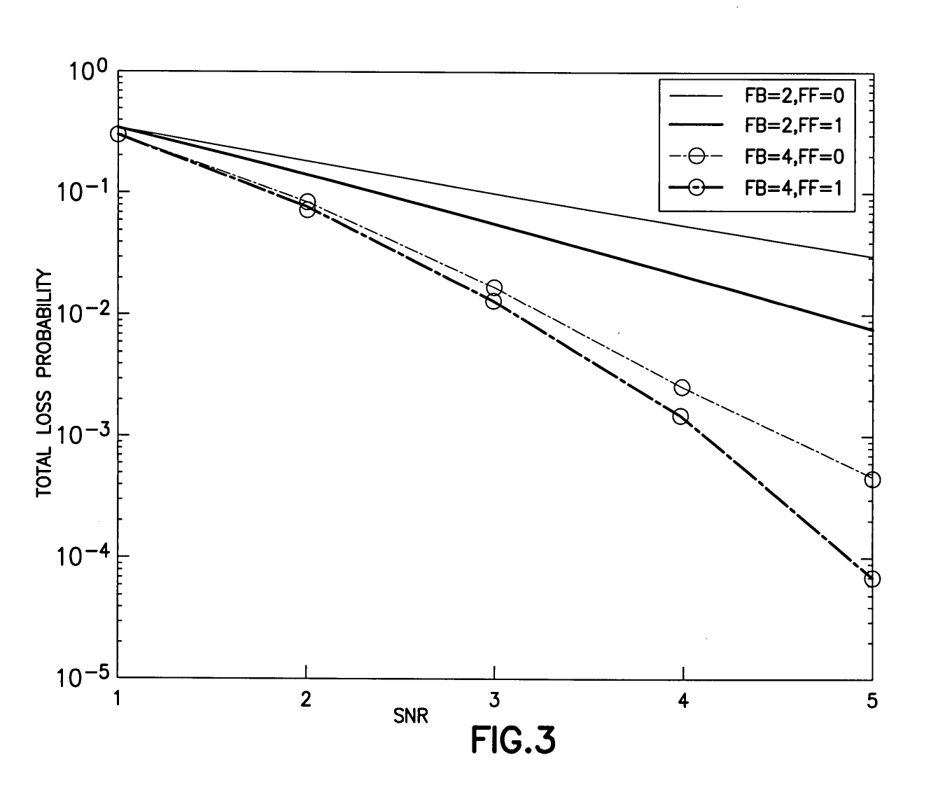

The optimization problem is then solved using numerical techniques; for example using standard built-in minimization functions in MATLAB. The results of the optimization are given in FIGS. 3-5 for various combinations of buffer sizes, FB and FF rates. For instance, “FB=2” in FIG. 3 means that the FB rate is two bits for FB information 194 per time-slot, and “FF=1” means that the FF rate is one bit for FF information 193 per time-slot. It should be reiterated that finite buffer sizes result in a bound on the average packet delay. Further, if a first-come-first-serve policy is considered, finite buffer sizes also impose an upper bound on the absolute packet delay.

It is clear from FIGS. 3-5 that adding even one bit of FF information 193 can substantially reduce the outage probabilities (around one dB in some cases) and thus implementing them in practical systems with limited amount of FB information 194 and FF information 193 can still lead to substantial improvements in performance. The parameter choices in FIG. 2A through FIG. 6 satisfy the condition

$$( 1 + \frac{L ( L + 1 )}{2} ) \leq {2}^{{N}_{f} + {N}_{b}} .$$

In practical scenarios, if not enough FF or FB bits are available, then the proposed technique can still be used but by limiting buffer occupancy to lesser than full capacity, such that effective buffer size satisfies the relation given above.

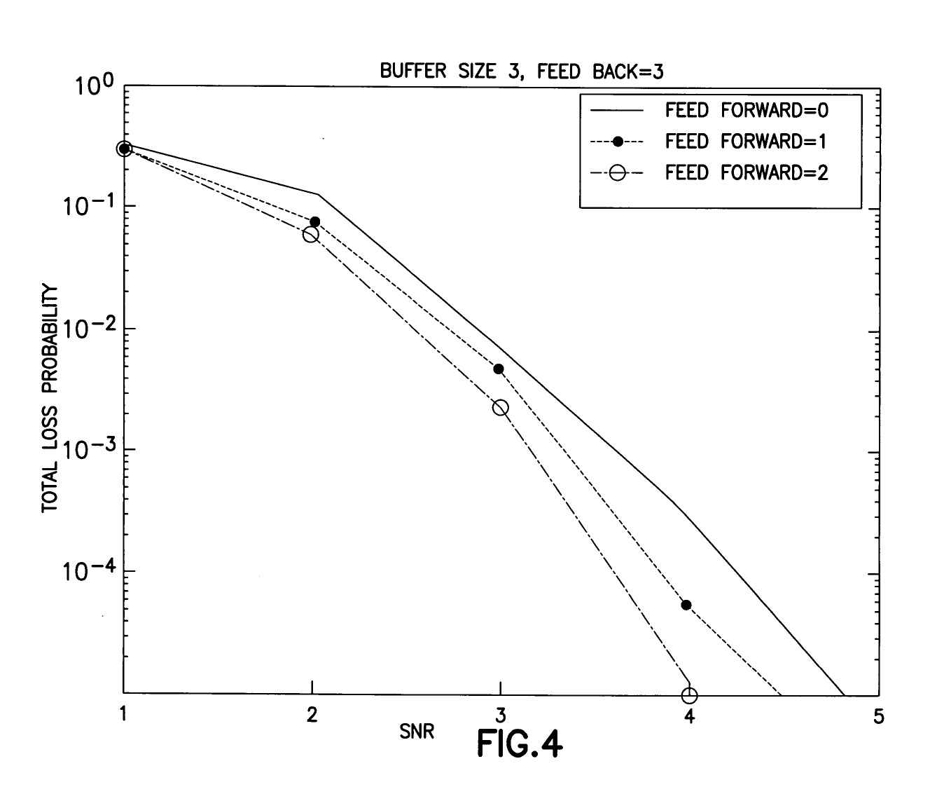

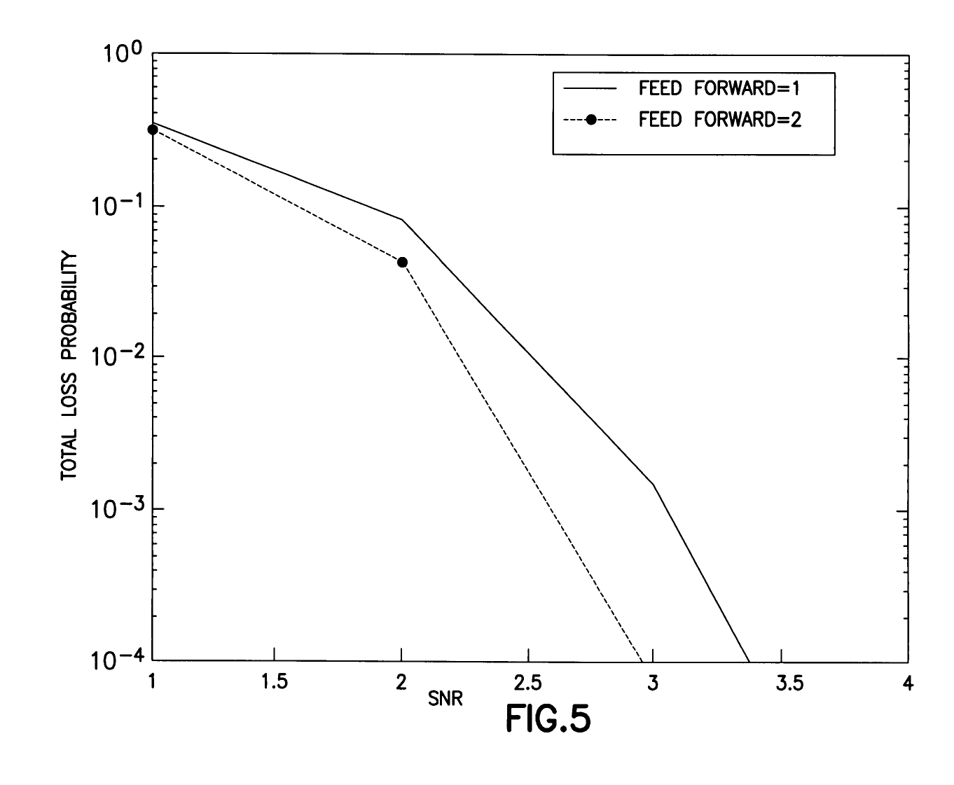

An exemplary wireless communication system 100 has been described above with respect to FIGS. 1-5 FIGS. 6A-10 describe another exemplary embodiment, shown in FIG. 6A.

Turning now to FIG. 6A, part 600 of a transmission portion 600 (e.g., transmission portion 130) of a transmitter (e.g., transmitter 110) is shown. The transmission portion 600 allows multirate transmissions. Part 600 comprises a channel coding module 620 that accepts input bits and produces coded bits 625. A variable rate modulation module 630 produces output bits 640 by using one of the modulation schemes shown in FIGS. 6B (two bits), 6C (four bits), or 6D (six bits). The following is assumed for a wireless communication system (e.g., wireless communication system 100) using the part 600: (1) the packet size is 25 bits; (2) the channel code is rate ½ convolutional code; (3) the constraint length is 3 and generator polynomial in octal digits is [5 7]; (4) there is a Rayleigh fading channel; (5) there is perfect CSI at the receiver; (6) one time-slot=50 channel symbols; (7) there is a constant rate for packet arrivals; and (8) there are three different transmission rates.

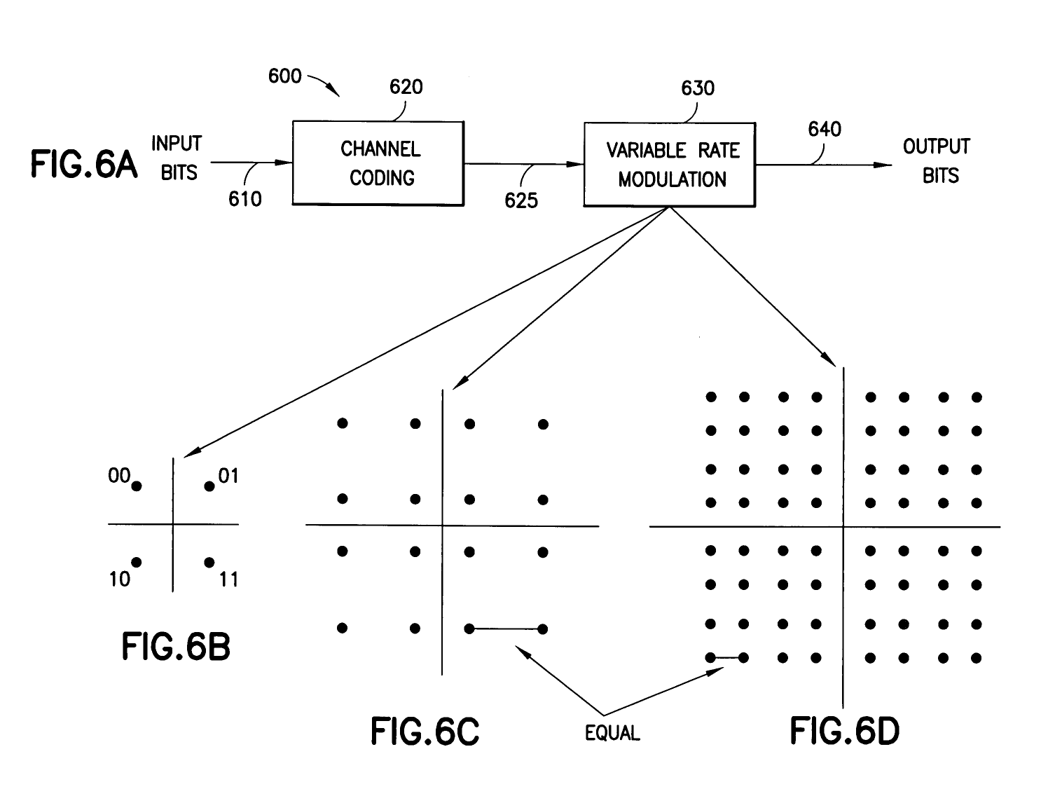

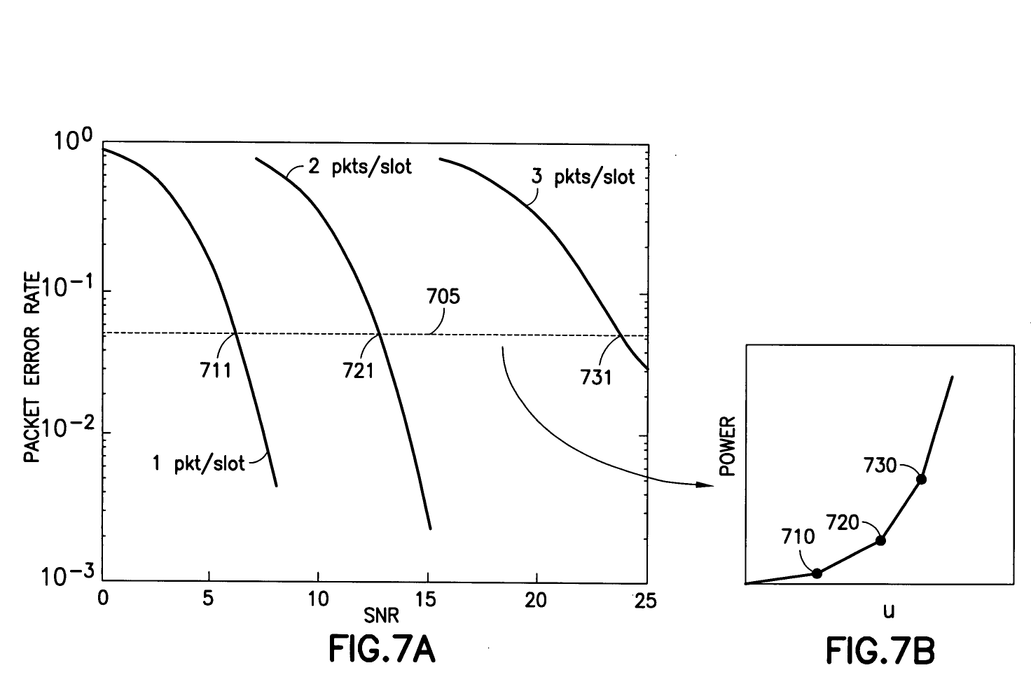

Referring now to FIG. 7A, a graph is shown of packet error rate for the multirate scheme shown in FIG. 6A, for a number of packets per time-slot. FIG. 7B shows a graph, determined using FIG. 7A, of transmission power for number of packets per slot (u). For instance, point 710 is chosen by using a selected 705 packet error rate of 0.05. In the examples of FIGS. 7A and 7B, no FF information 193 was used. Points 710, 720, 730 in FIG. 7B correspond to points 711, 721, and 731 of FIG. 7A.

The problem is formulated as above, except that the transmitted power 180, Pₜ, is determined differently:

$${P}_{t} = f ( {q}_{t} , {\hat{γ}}_{t} , channel\_FER ) , \\ {\hat{γ}}_{t} = g ( {γ}_{t} , {\hat{q}}_{t} ) , \\ {\hat{q}}_{t} = e ( {q}_{t} ) , and$$

$${min}_{\{ f , g , e \}} Π given E [ {P}_{t} ] \leq {P}_{0} .$$

where channel_FER is frame error rate (FER) in the channel. Furthermore, the total packet loss rate Π is buffer overflow probability +channel_FER (1−buffer overflow probability).

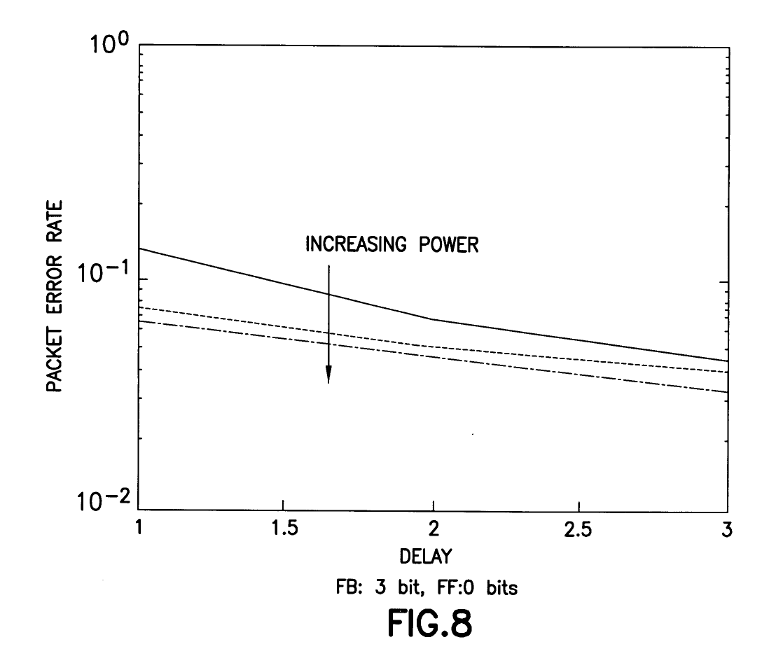

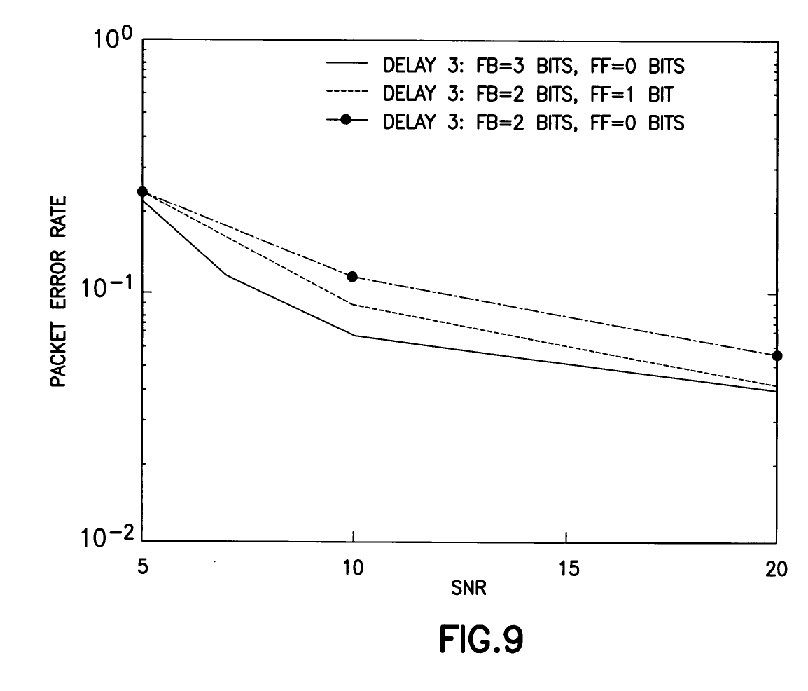

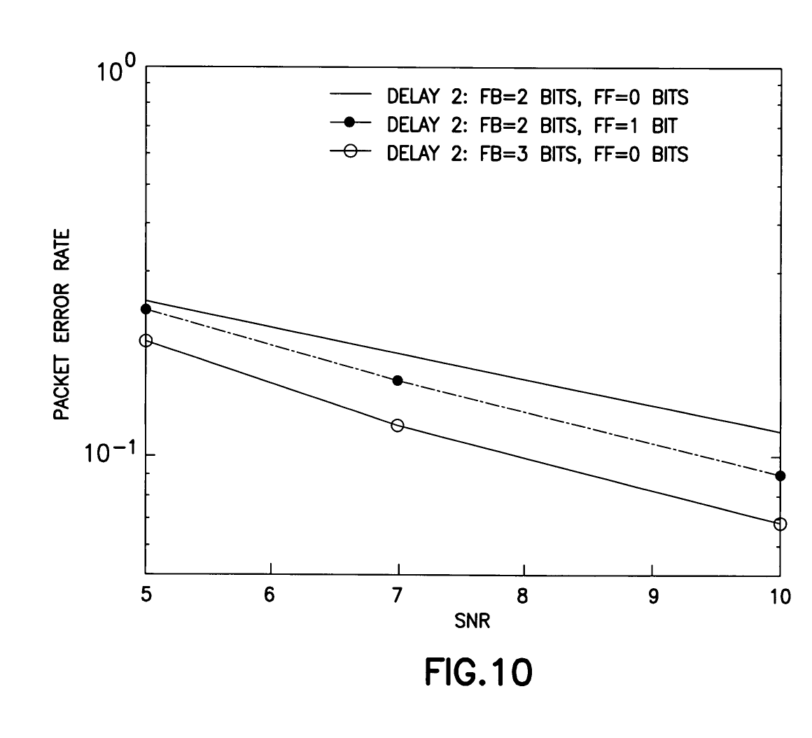

An exemplary problem solution includes realizing that the number of values for qₜ is small, and therefore optimization over e(·) is easy. In a first case, the channel FER can be fixed and then one can optimize over f(·) and g(·). Additionally, numerical optimization may be performed. Using these exemplary techniques, the packet error rate versus delay (FIG. 8), packet error rate versus signal to noise ratio (SNR) for a delay of three packets (FIG. 9), and packet error rate versus SNR for a delay of two packets (FIG. 10) may be determined. Delay is measured as time-slots (e.g., where one time-slot has T_{c} symbols). It should be noted that power and SNR are equivalent for a fixed noise variance through SNR=p/σ². FIGS. 9 and 10 show that adding one FF bit improves packet error rate.

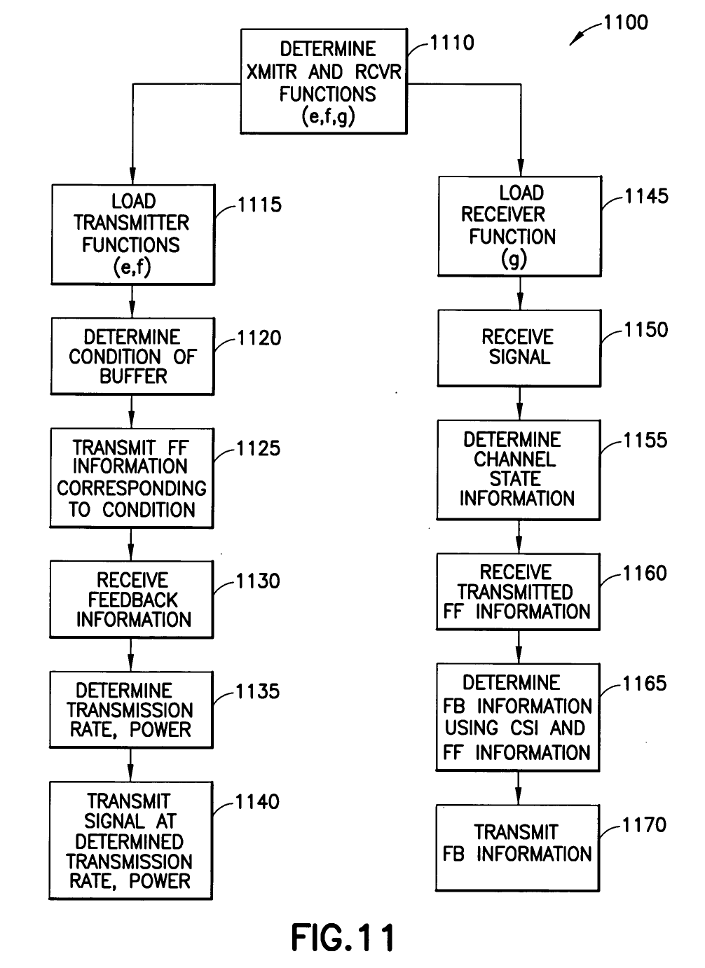

Turning now to FIG. 11, a method 1100 is shown for joint feed-forward and feedback for wireless communication systems. Method 1100 could be used, for example, in the systems described in reference to FIGS. 1 and 6A. In step 1110, the transmitter and receiver functions, e(·), f(·), and g(·), as described above are determined. Such determination could take place in the transmitter 110, receiver 150, both the transmitter 110 and receiver 150, or some other location(s). Typically, the determination of these functions includes optimization by

$${min}_{\{ f , g , e \}} Π$$

given E[Pₜ]≦P₀; however, optimization need not be performed.

Once the transmitter and receiver functions have been determined, then the transmitter functions (e.g., e(·) and f(·)) and the receiver function (e.g., g(·)) will be loaded into the transmitter and receiver, steps 1115 and 1145, respectively. Steps 1115-1140 are performed by a transmitter (e.g., transmitter 110) and steps 1145-1170 are performed by a receiver (e.g., receiver 150). It should be noted that the transmitter 110 can have reception functionality (e.g., reception portion 174) and similarly the receiver 150 can have transmitter functionality (e.g., transmission portion 166).

In step 1120, the condition of the buffer 120 is determined. As described above, step 1120 is typically performed by determining the amount, qₜ, of packets 135 in the buffer 120, although other techniques are possible. In step 1125, the FF information 193 is determined (e.g., by determining a quantized amount, \hat{q}ₜ, of packets 135 in the buffer 120) and transmitted from the transmitter 110 to a receiver 150.

In step 1130, the transmitter 110 receives FB information 194 from the receiver 150. The transmitter 110 in step 1135 determines the transmission rate 170 and transmission power 180 by using the transmitter functions e(·) and f(·. In step 1140, a signal is transmitted at (e.g., or beneath) the transmission rate 170 and at transmission power 180 (e.g., or at least at the transmission power 180) determined in step 1135.

The receiver receives a signal in step 1150, which is typically a signal transmitted by the transmitter 110 in a previous time-slot. The receiver 1150 determines channel state information in step 1155. The receiver also receives the transmitted FF information 193 in step 1160. Note that step 1160 could occur in a current time-slot (e.g., just prior to step 1150) or could occur in previous time-slots (e.g., a time-slot prior to step 1150).

In step 1165, the FB information 194 is determined using the receiver function, g(·), which uses the channel state information determined in step 1155 and the FF information 193 received in step 1165. In step 1170, the receiver 150 transmits the FB information 194 to the transmitter 110.

While scalar quantization has been described herein, it should be noted that other techniques might be used. For instance, vector quantization may be used. Typically, vector quantization will use information from previous time-slots (e.g., and possibly the current time-slot), when determining quantization in a current time-slot).

FIG. 11 assumes that step 1110 is performed before the transmitter 110 and receiver 150 are operated. If the channel statistics and traffic statistics are known before hand, the determination of the transmitter and receiver functions (step 1110) can be done beforehand. The determination of transmitter and receiver functions could also be performed at other times. For instance, it could also happen that channel statistics (e.g., channel state information over a time period) and traffic statistics (e.g., transmission rate 170 over the time period) are performed using sliding windows in real-time. Thus, the determination of the functions in step 1110 can be carried out in real-time. Moreover, the determination of the functions in step 1110 could be done on a much slower time-scale and hence every time step 1110 is performed, the transmitter 110 and receiver 150 can be made to have the same functions e(·), f(·), and g(·).

As described above, embodiments of this invention including means and steps thereof may be implemented by circuitry such as computer software executable by one or more processors (e.g., signal processors) in each of the transmitter 110 and receiver 150, software, or a combination of software and hardware. Further in this regard, it should be noted that the various blocks of the flow diagram of FIG. 11 may represent program steps, or interconnected logic circuits, blocks and functions, or a combination of program steps and logic circuits, blocks and functions for performing the specified tasks. Additionally, embodiments of the present invention may be implemented as a signal bearing medium tangibly embodying a program of machine-readable instructions executable by a processing apparatus (e.g., transmitter 110 and/or receiver 150) to perform operations for joint feed-forward and feedback design for wireless communication systems.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. Nonetheless, all such and similar modifications of the teachings of this invention will still fall within the scope of this invention.

As an example of modifications that might be used, the functions given above can be nonlinear. For instance, the function e(·) could also include nonlinear combinations: for one bit FF information 193, qₜ=0, 1, 4 could be represented by \hat{q}ₜ=1 and qₜ=2, 3 could be represented by \hat{q}ₜ=2.

Furthermore, some of the features of the preferred embodiments of this invention could be used to advantage without the corresponding use of other features. As such, the foregoing description should be considered as merely illustrative of the principles of the present invention, and not in limitation thereof.

What is claimed is:

1. A method comprising:
determining a condition of a buffer in a transmitter;
using the condition, determining information corresponding to the condition; and
communicating the information to a receiver.

2. The method of claim 1, wherein:
the information is first information;
the method further comprises:
receiving second information from the receiver, the second information characterized by being determined using the first information and channel state information for a channel between the receiver and transmitter; and
using the first and second information, determining transmission rate and transmission power.

3. The method of claim 2, wherein the buffer stores packets, and wherein determinations of the first and second information, the transmission rate and the transmission power are performed so as to achieve a desired delay constraint for packet traffic on the channel between the transmitter and receiver.

4. The method of claim 3, wherein:
determining information further comprises determining the first information by applying a first function to a value for the condition;
the second information is characterized by being determined using a second function applied to the first information and to the channel state information for the channel between the receiver and transmitter;
using the first and second information, determining transmission rate and transmission power further comprises by using a third function applied to the first and second information, determining transmission rate and transmission power; and
the first, second, and third functions are performed so as to achieve the desired delay constraint.

5. The method of claim 1, wherein:
the buffer stores packets;
determining a condition further comprises determining a number of packets stored in the buffer;
determining information corresponding to the condition further comprises quantizing the number of packets into one of a predetermined number of bit combinations; and
communicating further comprises communicating the one bit combination through a channel to the receiver.

6. The method of claim 1, wherein:
the buffer stores packets;
determining the condition further comprises determining a number of packets that arrive within a time window;
determining information corresponding to the condition further comprises quantizing the number of packets that arrived in the time window into one of a predetermined number of bit combinations; and
communicating further comprises communicating the one bit combination through a channel to the receiver.

7. The method of claim 1, wherein:
the buffer stores packets;
determining the condition further comprises determining a maximum waiting time of packets in the buffer;
determining information corresponding to the condition further comprises quantizing the maximum waiting time of packets in the buffer into one of a predetermined number of bit combinations; and
communicating further comprises communicating the one bit combination through a channel to the receiver.

8. The method of claim 1, wherein:
determining information corresponding to the condition further comprises quantizing, using a predetermined function, a value for the condition into a given one of a predetermined number of bit combinations; and
communicating further comprises communicating the given bit combination through a channel to the receiver.

9. The method of claim 1, wherein the information is first information, wherein the buffer stores packets, and wherein the method further comprises:
receiving second information from the receiver;
using the condition of the buffer and the second information, determining transmission power; and
at a power that is at least the determined transmission power, communicating at least one packet in the buffer to the receiver though a channel.

10. The method of claim 1, wherein the information is first information, wherein the buffer stores packets, and wherein the method further comprises:
receiving second information from the receiver;
using the condition of the buffer and the second information, determining transmission rate; and
communicating a number of packets that meets or is below the transmission rate to the receiver though a channel.

11. The method of claim 1, wherein the information is first information, wherein the buffer stores packets, and wherein the method further comprises:
receiving second information from the receiver;
using the condition of the buffer and the second information, determining transmission power and transmission rate; and
at a power that is at least the determined transmission power, communicating a number of packets that meets or is below the transmission rate to the receiver though a channel.

12. The method of claim 11, wherein the first information comprises N_{f} bits, the second information comprises N_{b} bits, a chosen size of the buffer is L, and N_{f} and N_{b} are chosen to meet
$$( 1 + \frac{L ( L + 1 )}{2} ) \leq {2}^{{N}_{f} + {N}_{b}} .$$

13. The method of claim 11, wherein determining transmission power and transmission rate further comprises determining transmission power and transmission rate through a least one function of (qₜ, ŷₜ), where qₜ corresponds to the condition of the buffer and \hat{γ}ₜ corresponds to the second information.

14. A transmitter comprising a buffer storing packets, a circuit that determines a condition of the buffer, a reception portion that receives information from a receiver, and a circuit using the condition and the information to determine at least one transmission parameter, wherein the determinations of the condition and the at least one transmission parameter are performed to achieve a desired delay constraint for packet traffic over a channel from the transmitter to the receiver.

15. The transmitter of claim 14, wherein the information is first information, wherein the circuit that determines the condition of the buffer uses the condition to determine second information corresponding to the condition, and wherein the transmitter further comprises a transmission portion coupled to the buffer and to the circuit that determines the condition of the buffer, the transmission portion communicates the second information to a receiver.

16. The transmitter of claim 15, wherein:
the at least one parameter comprises transmission power;
the buffer stores packets;
using the condition of the buffer and the first information, the circuit that determines the at least one transmission parameter determines the transmission power; and
the transmission portion communicates, at a power that is at least the determined transmission power, at least one packet in the buffer to the receiver though a channel;
wherein the determinations of the condition and the transmission power are performed so as to achieve the desired delay constraint.

17. The transmitter of claim 15, wherein:
the at least one parameter comprises transmission rate;
the buffer stores packets;
the transmitter further comprises a scheduler coupled between the buffer and the transmission portion;
using the condition of the buffer and the first information, the circuit that determines the at least one transmission parameter determines the transmission rate; and
the transmission portion communicates a number of packets provided by the scheduler to the receiver though a channel, wherein the number of packets meets or is below the transmission rate;
wherein the first and second processes are performed so as to achieve the desired delay constraint.

18. A transmitter comprising:
means for storing packets;
means for determining a condition of the means for storing packets;
means responsive to the condition for determining information corresponding to the condition; and
means for communicating the information to a receiver.

19. The transmitter of claim 18, wherein:
the information is first information;
the transmitter further comprises:
means for receiving second information from the receiver;
means responsive to the condition of the buffer and the second information for determining transmission power and transmission rate; and
means for communicating, at a power that is at least the determined transmission power, a number of packets that meets or is below the transmission rate to the receiver though a channel.

20. A signal bearing medium tangibly embodying a program of machine-readable instructions executable by a processing apparatus to perform operations comprising:
determining a condition of a buffer in the transmitter;
using the condition, determining information corresponding to the condition; and
communicating the information to a receiver.

21. The signal bearing medium of claim 20, wherein the information is first information, wherein the buffer stores packets, and wherein the operations further comprise:
receiving second information from the receiver;
using the condition of the buffer and the second information, determining transmission power and transmission rate; and
at a power that is at least the determined transmission power, communicating a number of packets that meets or is below the transmission rate to the receiver though a channel.

22. A method comprising:
step for determining a condition of a buffer in the transmitter;
using the condition, step for determining information corresponding to the condition; and
step for communicating the information to a receiver.

23. The method of claim 22, wherein the information is first information, wherein the buffer stores packets, and wherein the method further comprises:
step for receiving second information from the receiver;
using the condition of the buffer and the second information, step for determining transmission power and transmission rate; and
at a power that is at least the determined transmission power, step for communicating a number of packets that meets or is below the transmission rate to the receiver though a channel.

24. A method comprising:
receiving first information corresponding to a condition of a buffer in a transmitter;
determining channel state information for a channel from the transmitter to the receiver;
using the first information and the determined channel state information, determining second information; and
communicating the second information to the transmitter.

25. The method of claim 24, wherein determining second information further comprises using a function that quantizes the channel state information and the first information into the second information, wherein the second information comprises one of a predetermined plurality of bit combinations.

26. The method of claim 25, wherein the buffer stores packets, the function uses selection of thresholds γ_{k,l}, 1≦l≦k<L, where \hat{q}ₜ is the first information, L is a number of packets for a chosen buffer size, γₜ is channel state information, such that during time-slot t, l packets are transmitted from the transmitter to the receiver if \hat{q}ₜ=k and γ_{k,l}≦γₜ<γ_{k,l+1}.

27. The method of claim 24, wherein the first information comprises N_{f} bits, the second information comprises N_{b} bits, a chosen size of the buffer is L, and N_{f} and N_{b} are chosen to meet
$$( 1 + \frac{L ( L + 1 )}{2} ) \leq {2}^{{N}_{f} + {N}_{b}} .$$

28. The method of claim 24, wherein:
the first information is determined through a first function;
determining second information further comprises using a second function that determines the second information by using the first information and the determined channel state information;
a number of packets is communicated from the transmitter to the receiver through the channel and is communicated using a transmission power;
the number of packets is determined using a transmission rate;
the transmission rate and transmission power are determined through use of a third function.

29. The method of claim 28, wherein the first, second, and third functions are performed so as to achieve a desired delay constraint for packet traffic on the channel.

30. A receiver comprising a reception portion, a channel estimator, and a circuit, the reception portion receiving first information from a transmitter, the first information corresponding to a condition of a buffer of the transmitter, the channel estimator determining channel state information for a channel from the transmitter to the receiver, the circuit determining second information using the first information and channel state information, the determination of the second information performed so that a desired delay constraint for packet traffic over the channel is achieved.

31. The receiver of claim 36, further comprising a transmission portion that communicates the second information to the transmitter.

32. The receiver of claim 31, wherein the circuit that determines the second information further comprises a channel quantizer that quantizes the channel state information and the first information into the second information, wherein the second information comprises one of a predetermined plurality of bit combinations.

33. The receiver of claim 32, wherein the buffer stores packets, the quantizer uses a function to quantize the channel state information and the first information into the second information, the function uses selection of thresholds γ_{k,l}, 1≦l≦k<L, where \hat{q}ₜ is the first information, L is a number of packets for a chosen buffer size, γₜ is channel state information, such that during time-slot t, l packets are transmitted from the transmitter to the receiver if \hat{q}ₜ=k and γ_{k,l}≦γₜ<γ_{k,l+1}.

34. The receiver of claim 30, wherein the first information comprises N_{f} bits, the second information comprises N_{b} bits, a chosen size of the buffer is L, and N_{f} and N_{b} are chosen to meet
$$( 1 + \frac{L ( L + 1 )}{2} ) \leq {2}^{{N}_{f} + {N}_{b}} .$$

35. The receiver of claim 30, wherein:
the first information is determined through a first function;
the circuit that determines second information further comprises a channel quantizer that uses a second function that determines the second information by using the first information and the determined channel state information;
a number of packets is communicated from the transmitter to the receiver through the channel and is communicated using a transmission power;
the number of packets is determined using a transmission rate; and
the transmission rate and transmission power are determined through use of a third function; and
wherein the first, second, and third functions are performed to achieve the desired delay constraint for packet traffic on the channel.

36. A receiver comprising:
means for receiving first information corresponding to a condition of a buffer in a transmitter;
means for determining channel state information for a channel from the transmitter to the receiver;
means responsive to the first information and the determined channel state information for determining second information; and
means for communicating the second information to the transmitter.

37. The receiver of claim 36, wherein the means for determining second information further comprises means for quantizing the channel state information and the first information into the second information, wherein the second information comprises one of a predetermined plurality of bit combinations.

38. A method comprising:
step for receiving first information corresponding to a condition of a buffer in a transmitter;
step for determining channel state information for a channel from the transmitter to the receiver;
using the first information and the determined channel state information, step for determining second information; and
step for communicating the second information to the transmitter.

39. The method of claim 38, wherein the step for determining second information further comprises step for quantizing the channel state information and the first information into the second information, wherein the second information comprises one of a predetermined plurality of bit combinations.

40. A signal bearing medium tangibly embodying a program of machine-readable instructions executable by a processing apparatus to perform operations comprising:
receiving first information corresponding to a condition of a buffer in a transmitter;
determining channel state information for a channel from the transmitter to the receiver;
using the first information and the determined channel state information, determining second information; and
communicating the second information to the transmitter.

41. The signal bearing medium of claim 40, wherein determining second information further comprises quantizing the channel state information and the first information into the second information, wherein the second information comprises one of a predetermined plurality of bit combinations.

42. A method comprising:
gathering channel state information statistics and transmission rate statistics for a channel between a transmitter and a receiver;
performing the following using the channel state information statistics and transmission rate statistics:
determining a first function used to calculate first information based on a condition of a buffer of the transmitter;
determining a second function used to calculate second information based on channel state information and the first information;
determining a third function used to calculate transmission power and transmission rate based on the second information and the condition of the buffer.

43. The method of claim 30, further comprising communicating the first and third function to the transmitter and communicating the second function to the receiver.

44. The method of claim 42, wherein:
the condition comprises qₜ;
the first function comprises \hat{q}ₜ=e(qₜ;
the second function comprises \hat{γ}ₜ=g(γₜ, \hat{q}ₜ), where the channel state information comprises γₜ; and
the third function comprises Pₜ=f(qₜ, \hat{γ}ₜ), where transmission power comprises Pₜ and transmission rate is also determined using f(qₜ,\hat{γ}ₜ).

45. The method of claim 44, wherein e(·), f(·), g(·) are determined through:
$${min}_{\{ f , g , e \}} Π given E [ {P}_{t} ] \leq {P}_{0} ,$$
where Π is a probability of buffer overflow, and P₀ is a maximum power of the transmitter.

46. The method of claim 42, wherein:
the condition comprises qₜ;
the buffer stores packets;
the first function comprises a thresholding function that determines \hat{q}ₜ from qₜ, the second and third functions use selected thresholds γ_{k,l}, 1≦l≦k≦L, where L is a number of packets for a chosen buffer size, γₜ is channel state information, such that during time-slot t, l packets are transmitted if \hat{q}ₜ=k for the second function, if qₜ=k for the third function, and γ_{k,l}≦γₜ<γ_{k,l+1}. γ_{k,l}, 1≦l≦k≦L.
